(19) United States
(12) Patent Application Publication
(10) Pub. No.: US 2017/0115474 A1
(43) Pub. Date: Apr. 27, 2017

(54) IMAGING OPTICAL SYSTEM, ILLUMINATION APPARATUS, AND OBSERVATION APPARATUS

(71) Applicant: OLYMPUS CORPORATION, Tokyo (JP)

(72) Inventor: Hiroya FUKUYAMA, Tokyo (JP)

(73) Assignee: OLYMPUS CORPORATION, Tokyo (JP)

(21) Appl. No.: 15/402,457

(22) Filed: Jan. 10, 2017

Related U.S. Application Data
(63) Continuation of application No. PCT/JP2015/070462, filed on Jul. 16, 2015.

(30) Foreign Application Priority Data
Jul. 25, 2014 (JP) 2014-152345

(51) Int. Cl. G02B 21/00; G01J 1/44; G02B 21/02

(52) U.S. Cl. CPC G02B 21/006; G02B 21/0032; G02B 21/0076; G02B 21/008; G02B 21/02; G01J 1/44

(57) ABSTRACT

In order to obtain a clear final image by preventing scratches, foreign objects, defects, or the like of an optical device from becoming superimposed on an intermediate image even when the intermediate image is formed at a position that overlaps with the optical device, this imaging optical system has a plurality of imaging lenses that form a final image and at least one intermediate image; a first phase-modulating element disposed closer to an object than any one of the intermediate images, for imparting a spatial disturbance to a wavefront of light coming from the object; and a second phase-modulating element integrated with at least one optical element of the imaging lens, wherein the second phase-modulating element cancels the spatial disturbance imparted to the wavefront of the light coming from the object by the first phase-modulating element.

### CROSS-REFERENCE TO RELATED APPLICATIONS

This application is a Continuation Application of International Application No. PCT/JP2015/070462 filed on Jul. 16, 2015, which claims priority to Japanese Application No. 2014-152345 filed on Jul. 25, 2014. The contents of International Application No. PCT/JP2015/070462 and Japanese application No. 2014-152345 are incorporated herein by reference in its entirety.

### TECHNICAL FIELD

The present invention relates to an imaging optical system, an illumination apparatus, and an observation apparatus.

### BACKGROUND ART

There is a known method in which the position of an in-focus point is moved in a direction parallel to an optical axis by adjusting the optical path length at an intermediate-image position (for example, see PTL 1).

### CITATION LIST

### Patent Literature

### {PTL 1} Publication of Japanese Patent No. 4011704

### SUMMARY OF INVENTION

An aspect of the present invention is an imaging optical system comprising: a plurality of imaging lenses that form a final image and at least one intermediate image; a first phase-modulating element that is disposed closer to an object than any one of the intermediate images formed by the imaging lenses, and that imparts a spatial disturbance to a wavefront of light coming from the object; and a second phase-modulating element that is integrated with at least one optical element which constitutes the imaging lens and which is positioned at a vicinity of a pupil position of the imaging lens so that at least one of the intermediate images are positioned between the at least one optical element and the first phase-modulating element, wherein the second phase-modulating element cancels the spatial disturbance imparted to the wavefront of the light coming from the object by the first phase-modulating element.

### BRIEF DESCRIPTION OF DRAWINGS

FIG. 1 is a diagram schematically showing an observation apparatus according to a first embodiment of the present invention.

FIG. 2 is a diagram schematically showing an objective lens of an imaging optical system shown in FIG. 1.

FIG. 3A is a plan view showing a cylindrical lens another modified example of a phase modulation element used in the imaging optical system shown in FIG. 1.

FIG. 3B is a side view showing the cylindrical lens the modified example of the phase modulation element used in the imaging optical system shown in FIG. 1.

FIG. 4 is a diagram schematically showing a modified example of the objective lens.

FIG. 5A is a plan view showing an one-dimensional binary diffraction grating as another modified example of the phase modulation element used in the imaging optical system shown in FIG. 1.

FIG. 5B is a side view showing the one-dimensional binary diffraction grating as the modified example of the phase modulation element used in the imaging optical system shown in FIG. 1.

FIG. 6A is a plan view showing an irregularly shaped element as another modified example of the phase modulation element used in the imaging optical system shown in FIG. 1.

FIG. 6B is a side view showing the irregularly shaped element as the modified example of the phase modulation element used in the imaging optical system shown in FIG. 1.

FIG. 7 is a perspective view showing one-dimensional sinusoidal diffraction gratings as another modified example of the phase modulation element used in FIG. 1.

FIG. 8 is a perspective view showing free-curved surface lenses as another modified example of the phase modulation element used in FIG. 1.

FIG. 9 is a perspective view showing concentric circular binary diffraction gratings as another modified example of the phase modulation element used in FIG. 1.

FIG. 10 is a longitudinal sectional view showing cone lenses as another modified example of the phase modulation element used in FIG. 1.

FIG. 11 is a longitudinal sectional view showing spherical aberration elements as another modified example of the phase modulation element used in FIG. 1.

FIG. 12 is a longitudinal sectional view showing refractive index distributed type elements as another modified example of the phase modulation element used in FIG. 1.

FIG. 13 is a diagram schematically showing an observation apparatus according to a second embodiment of the present invention.

### DESCRIPTION OF EMBODIMENTS

An observation apparatus 1, an illumination apparatus 2, and an imaging optical system 3 according to a first embodiment of the present invention will be described below with reference to the drawings.

The observation apparatus 1 according to this embodiment is, for example, a laser scanning multiphoton excitation microscope.

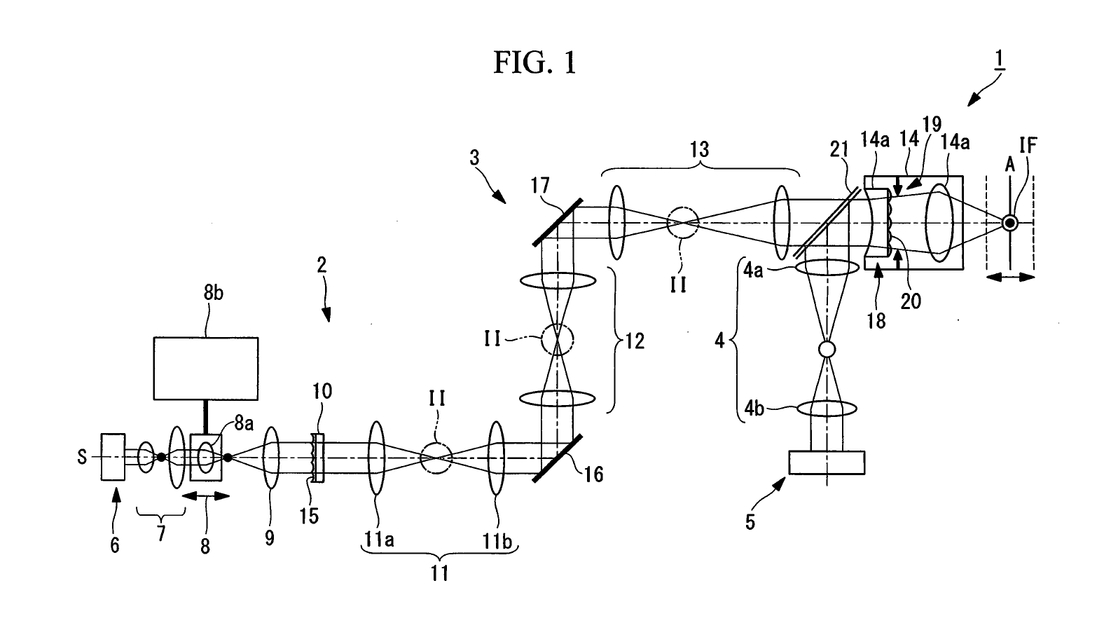

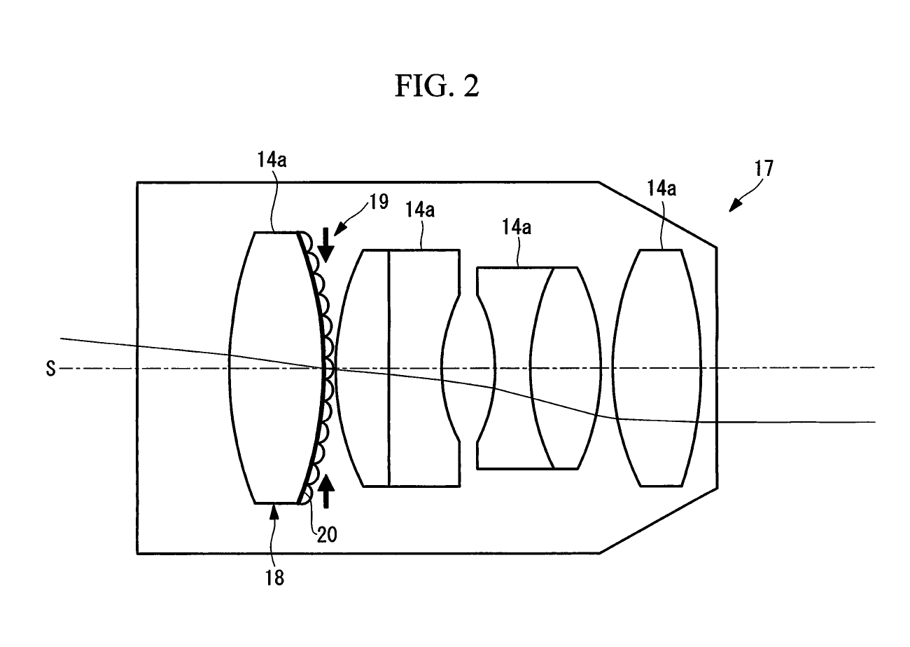

As shown in FIGS. 1 and 2, the observation apparatus 1 is provided with: an illumination apparatus 2 that radiates illumination light onto an observation subject A; a detector optical system 4 that guides, to a photodetector 5, fluorescence emitted from the observation subject A; and the photodetector 5 that detects the fluorescence guided thereto by the detector optical system 4.

The illumination apparatus 2 is provided with: an ultra-short pulse laser light source 6 (hereinafter simply referred to as light source) that is located at a subject side and that emits ultra-short pulse laser light (hereinafter simply referred to as laser light); and an imaging optical system 3 that radiates the laser light coming form the light source 6 onto the observation subject A.

The imaging optical system 3 is provided with: a beam expander 7 that expands the beam diameter of the laser light coming from the light source 6; a Z-scanning portion 8 that forms an intermediate image by focusing the laser light that has passed through the beam expander 7 and that is capable of moving the imaging position in the direction of the optical axis S; and a collimating lens 9 that turns the laser light into substantially collimated light.

The imaging optical system 3 is provided with: a wavefront disturbing element (first phase-modulating element) 10 that adds a disturbance on the wavefront of the laser light, which has been turned into the substantially collimated light; a plurality of relay lens pairs (imaging lens) 11, 12, and 13 that relay the intermediate image formed by the Z-scanning portion 8; an objective lens (imaging lens) 14 which radiates the laser light which has passed through the relay lens pairs 11, 12, 13 to the observation subject A and which focuses the fluorescence generated at the light-focusing point (final image IF) of the laser light at the observation subject A.

The Z-scanning portion 8 is provided with: a focusing lens 8a that focuses the laser light whose beam diameter has been expanded by the beam expander 7; and an actuator 8b that moves the focusing lens 8a in the direction of the optical axis S. By moving the focusing lens 8a in the direction of the optical axis S by means of the actuator 8b, it is possible to move the position at which the intermediate image is formed in the direction of the optical axis S.

The wavefront disturbing element 10 is provided with micro concave lenses which are arranged and formed of an optically transparent material which allows light to pass the lenses, which is called micro lens array. The wavefront disturbing element 10 adds, to the wavefront of the laser light, a phase modulation which changes in a two-dimensional direction orthogonal to the optical axis S in accordance with the shape of the surface 15 when the laser light passes through the element 10. In this embodiment, necessary disturbance of the wavefront is added by making the laser light, which is from the light source 6, pass through the element 10.

The relay lens pair 11 is configured so that the laser light that has been turned into substantially collimated light by the collimating lens 9 is focused by a first lens 11a to form an intermediate image II, and so that, subsequently, the spreaded laser light is collimated again by a second lens 11b to restore substantially collimated light. In this embodiment, the three relay lens pairs 11, 12, and 13 are disposed in a direction parallel to the optical axis S with spaces therebetween so that the intermediate images II are formed at three locations.

Each of the galvanometer mirrors 16 and 17 is provided so as to be pivotable about an axis orthogonal to the optical axis S, and is configured so as to, by changing the pivoting angle thereof, impart an inclination angle to the reflected laser light. The axes of the two galvanometer mirrors 16 and 17 are arranged in a mutually twisted positional relationship so that the inclination angles of the laser light can be changed in two-dimensional directions. Each of the two galvanometer mirrors 16 and 17 is disposed at a position that is optically conjugate with the pupil of the objective lens 14, described later, and to which the light is relayed by the relay lens pairs 12 and 13.

The objective lens 14 is provided with: a plurality of lenses 14a which form the final image IF; and a wavefront restoration element (second phase modulation element) 18 which is integrated with one of the lenses 14a, which is disposed at a vicinity of the pupil position of the objective lens 14. The reference symbol 19 indicates an aperture stop disposed at a pupil position of the objective lens 14.

The wavefront restoration element 18 is provided with micro convex lenses which are arranged and formed of an optically transparent material which allows light to pass the lenses, which is a micro lens array having a phase characteristic inverse to that of the wavefront disturbing element 10. The wavefront restoration element 18 adds, to the wavefront of the light, a phase modulation which changes in a two-dimensional direction orthogonal to the optical axis S in accordance with the shape of the surface 20 when the laser light passes through the element 18. In this embodiment, the wavefront restoration element 18 is configured to cancel the disturbance of the wavefront added by the wavefront disturbing element 10 by making the laser light pass through the element 18. The wavefront restoration element 18 is disposed at a position that is optically conjugate with the wavefront disturbing element 10.

The detector optical system 4 is provided with: a dichroic mirror 21 which branches fluorescence, which is focused by the objective lens 14, off from the optical pass of the laser light; and two focusing lenses 4a, 4b which focus the fluorescence branched off by the dichroic mirror 21.

The photodetector 5 is, for example, a photomultiplier tube and is configured so as to detect the intensity of the irradiated fluorescence.

The operation of the thus-configured imaging optical system 3, illumination apparatus 2, and observation apparatus 1 according to this embodiment will be described below.

In order to observe the observation subject A by using the observation apparatus 1 according to this embodiment, the observation subject A is irradiated with the laser light emitted from the light source 6 by means of the imaging optical system 3. After the beam diameter thereof is expanded by the beam expander 7, the laser light passes through the Z-scanning portion 8, the collimating lens 9, and the wavefront disturbing element 10.

The laser light is focused by the focusing lens 8a of the Z-scanning portion 8, and it is possible to adjust the light-focusing position thereof in the direction of the optical axis S by operating the actuator 8b.

In addition, by making the laser light pass through the wavefront disturbing element 10, a spatial disturbance is imparted to the wavefront thereof.

Next, the laser light is made to pass through the three relay lens pairs 11, 12, and 13 and the two galvanometer mirrors 16 and 17, the inclination angle of the beam bundle is changed, and the laser light passes through the dichroic mirror 21, while forming the intermediate images II. Then, the laser light is focused by the objective lens 14, and the final image IF is formed at the observation subject A.

The position of the in-focus point of the laser light, which is the position of the final image IF formed by the imaging optical system 3, is moved in the direction of the optical axis S by moving the focusing lens 8a by operating the actuator 8b. By this operation, it becomes possible to adjust the observation depth of the observation subject A. The in-focus point of the laser light at the observation subject A can be two-dimensionally scanned in the direction perpendicular to the optical axis S by pivoting the galvanometer mirrors 16 and 17.

By the function of the plurality of micro lenses which forms the wavefront disturbing element 10, the laser light to which the spatial disturbance on the wavefront is imparted by the wavefront disturbing element 10 is formed in an unclear image in which a plurality of images which are scattered in a space, which was a single image before the wavefront disturbing element 10, or formed in said plurality of images whose focuses are not adjusted. Then, the laser light passes is irradiated onto the objective lens 14 and passes through the wavefront restoration element 18, and thereby the spatial disturbance imparted by the wavefront disturbing element 10 is canceled. Therefore, it is possible to obtain a clear image when formed as the final image IF at the stages after passing through the wavefront restoration element 18.

In other words, since the intermediate image II becomes unclear and blurry, even in a case in which the intermediate image is positioned at a vicinity of an optical element which has scratches, foreign objects, defects or the like, it is possible to prevent a situation in which the final image IF formed at the observation subject A becomes unclear by preventing the scratches, foreign objects, defects or the like from being superimposed on the intermediate image. As a result, it is possible to form a very small spot as the final image IF.

In this case, with the imaging optical system 3 of this embodiment, since one of the lenses 14a, which compose the objective lens 14, is integrated with the wavefront restoration element 18, even in a case in which the space at a vicinity of the pupil position of the objective lens 14 is small, it is possible to position the element 18 at a position which is very close to the pupil position, which is advantageous in this technical field.

Thus, when the inclination angle of the light bundle is changed by the galvanometer mirrors 16, 17, it is possible to prevent the position of the light bundle passing through the wavefront restoration element 18 which is positioned at the pupil position from moving. Therefore, it is possible to impart the same wavefront modulation to the laser light. As a result, it becomes possible to surely cancel the spatial disturbance of the wavefront imparted by the wavefront disturbing element 10, which is advantageous in this technical field.

Since the very small spot is formed at the observation subject A, photon density can be increased at a very small area and then fluorescence is generated. The generated fluorescence is focused by the objective lens 14 and branched off by the dichroic mirror 21, and then the fluorescence is focused by the detector optical system 4 and detected by the photodetector 5.

Each fluorescence images of the observation subject A is obtained by memorizing the fluorescence intensity detected by the photodetector 5 together with the scanned position by the galvanometer mirrors 16, 17 and the actuator 8b. Thus, with the observation apparatus 1 according to this embodiment, the fluorescence is generated in the very small spot area at each scanned position, it is possible to obtain fluorescence images having a high spatial resolution, which is advantageous in this technical field.

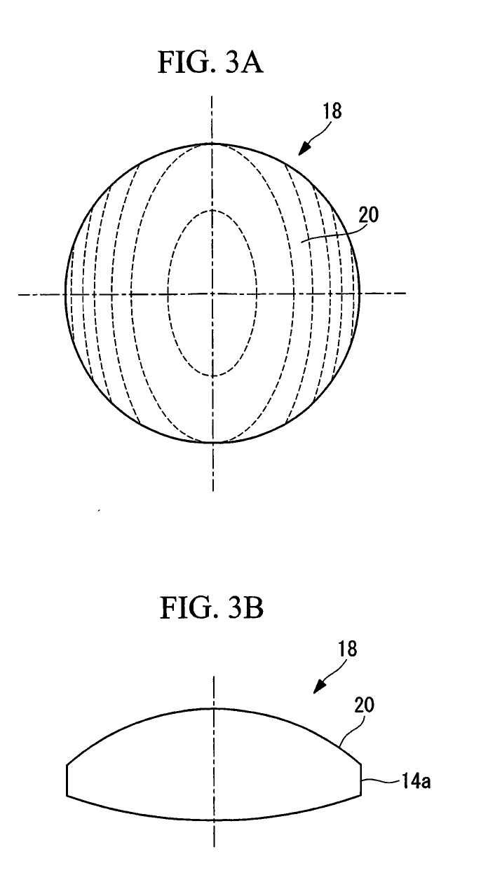

Although this embodiment employed the micro lens arrays as the wavefront disturbing element 10 and the wavefront restoration element 18 as an example, the cylindrical lens shape shown in FIGS. 3A and 3B may be employed instead of the micro lens array, for example.

In this case, when the plurality of intermediate images II are formed by the relay lens pairs 11, 12, 13, the images are made unclear by astigmatism.

FIGS. 3A and 3B show one of the lenses 14a which compose the objective lens 14, the surface 20 of the lens 14a has a toric shape in which the shape has two curvatures of different sizes in the two mutually perpendicular directions, respectively, which functions as the wavefront restoration element 18 which provides phase modulation having one dimensional distribution, and said difference between the two curvatures is similar to a cylindrical lens.

The dashed lines in FIG. 3 are contour lines representing a difference, in the direction of the optical axis S, between the surface 20 and a reference spherical shape which is close to the toric shape.

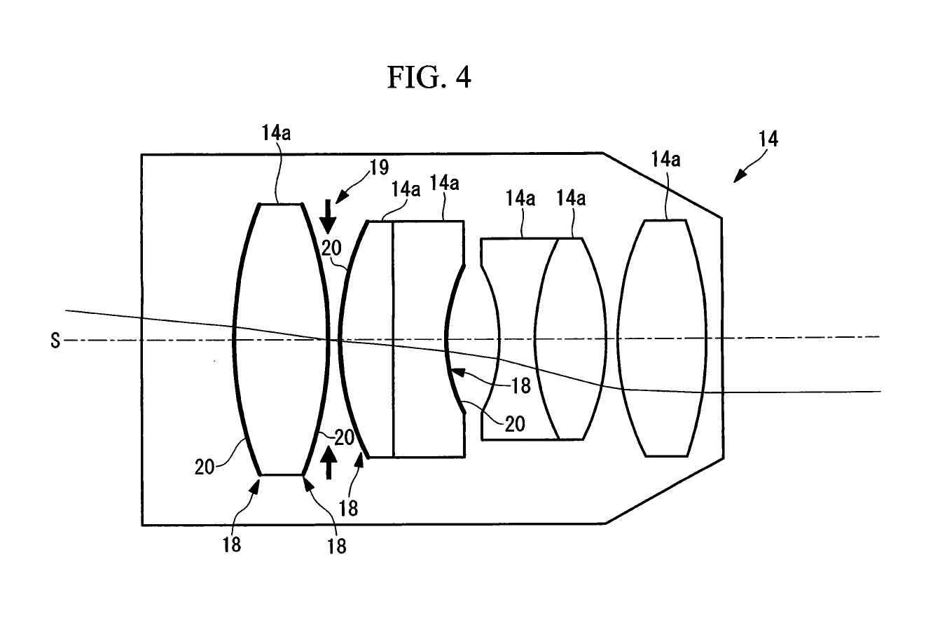

As the wavefront restoration element 18 which cancels the spatial disturbance of the wavefront imparted by the wavefront disturbing element 10, this embodiment employed one which is integrated with a single lens 14a. However, it is possible to employ wavefront restoration elements 18 which are integrated with the plurality of lenses 14a as shown in FIG. 4.

Especially, it is preferable that each wavefront restoration elements 18 has a cylindrical lens shape as shown in FIGS. 3A and 3B. when such plurality of wavefront restoration elements 18 each of which has the cylindrical lens shape and which are integrated with the plurality of lenses 14a, respectively, are employed, it is possible to consider and treat in simulation the plurality of the elements 18 as a single wavefront restoration element 18 as well as the plurality of the lenses 14a arranged in the direction of the optical axis S with spaces, which are considered and treated in simulation as a single lens. Further, it is possible to position the wavefront restoration element 18 treated in the aforementioned way so as to be close to the pupil surface of the imaging lens 14 having the wavefront restoration element 18, or to be consistent with the pupil surface.

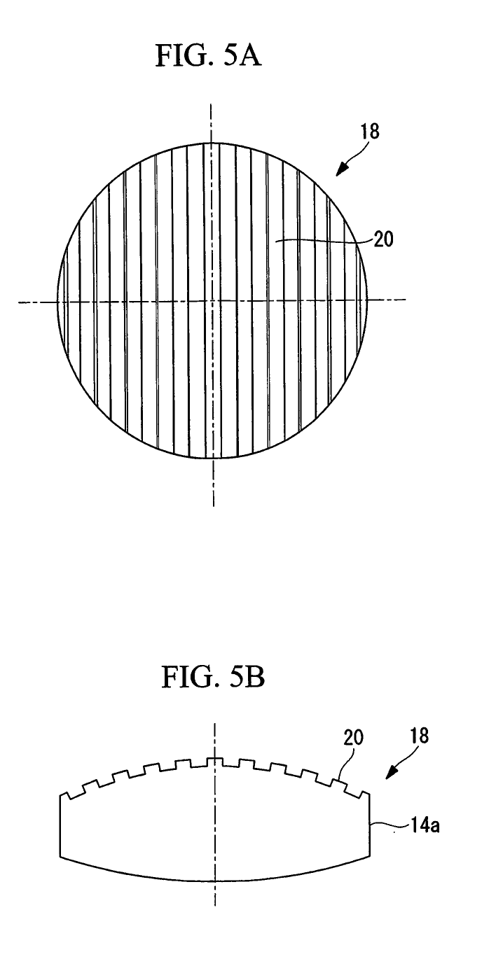

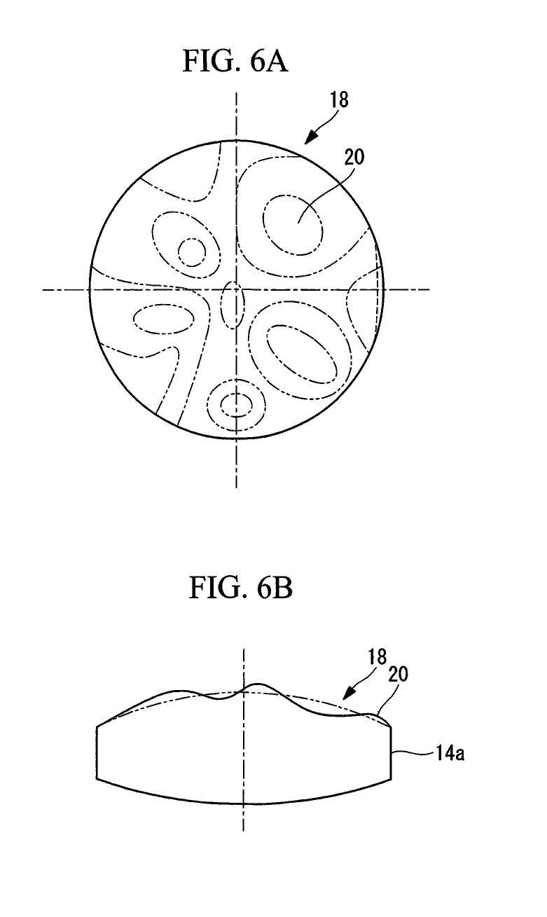

Although this embodiment employed the micro lens arrays as the wavefront disturbing element 10 and the wavefront restoration element 18, it is also possible to employ the one-dimensional binary diffraction grating shown in FIGS. 5A and 5B or the irregularly shaped element shown in FIGS. 6A and 6B.

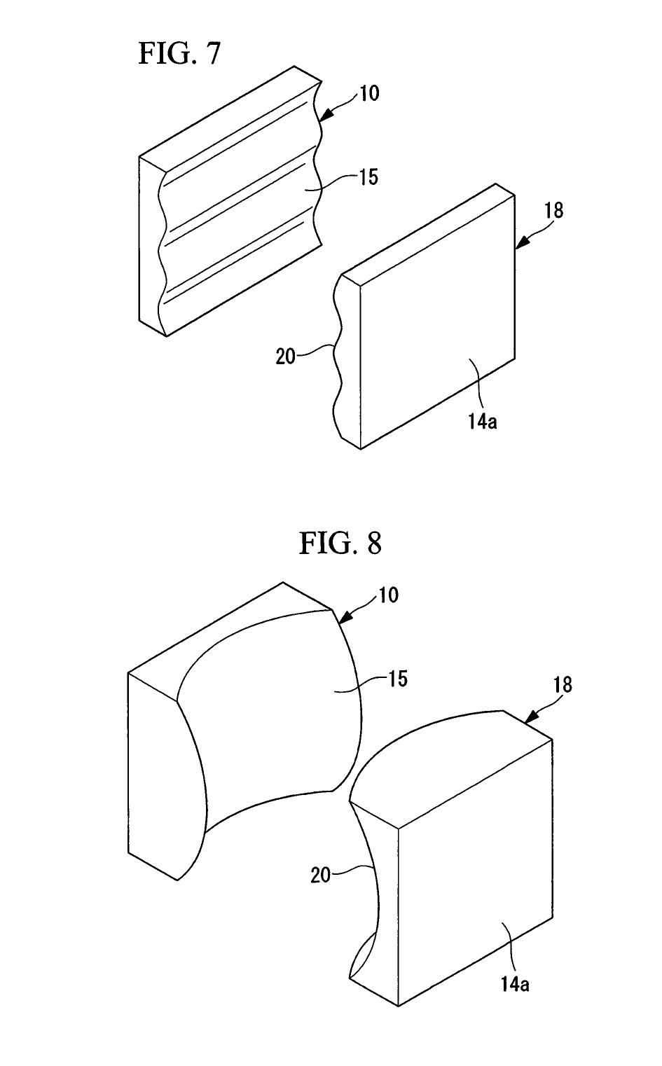

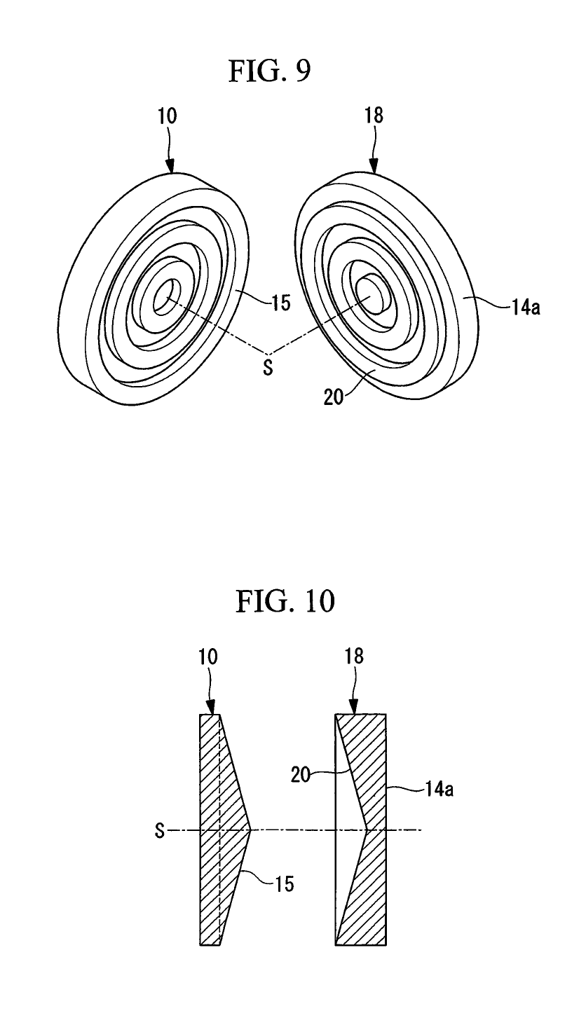

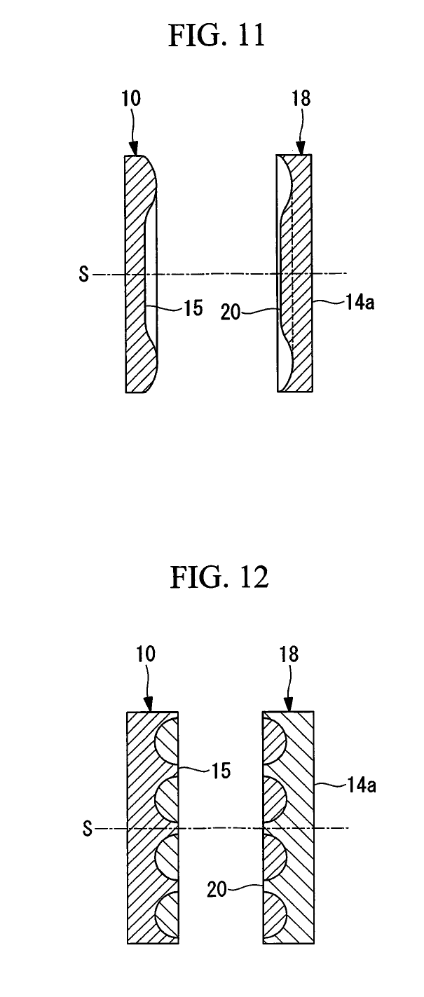

Also, it is possible to employ the wavefront disturbing element 10 and the wavefront restoration element 18 whose surfaces 15, 20 have mutually complementary shapes, each of which adds the phase modulation to the wavefront of the laser light. For example, as the wavefront disturbing element 10 and the wavefront restoration element 18, it is possible to employ the one-dimensional sinusoidal diffraction gratings shown in FIG. 7, the free-curved surface lenses shown in FIG. 8, the concentric circular binary diffraction gratings shown in FIG. 9, the cone lenses shown in FIG. 10, the spherical aberration elements shown in FIG. 11, or the refractive index distributed type elements shown in FIG. 12. The concentric circular type diffraction grating is not limited to the binary type, and any type, such as blazed type, sine wave type, or etc. may be employed.

When employing the aforementioned configuration, since the same optical material can be used for the wavefront disturbing element 10 which imparts the spatial disturbance to the wavefront for making the intermediate image II unclear, and for the wavefront restoration element 18 which cancels the spatial disturbance imparted to the wavefront by the wavefront disturbing element 10, it becomes easy to produce them.

Also, the lens 14a is shown as an example optical element which is integrated with the wavefront restoration element 18 in this embodiment. In another embodiment, it is possible to integrate the element 18 with another kind of optical element, such as a filter, protective glass, prism, or etc. which composes the objective lens 14.

Further, this embodiment showed an example in which the wavefront disturbing element 10 which is positioned at a side closer to the light source 6 than one of the intermediate images II and which is separated from the lenses is employed. In another embodiment, it is possible to employ a wavefront disturbing element 10 which is integrated with a lens which is positioned at a side closer to the light source 6 relative to one of the intermediate images II.

Also, the surfaces 15, 20 of the wavefront disturbing element 10 and the wavefront restoration element 18 may be disposed so that they face the light source 6 or the observation subject A.

Also, as an example, the observation apparatus 1 of this embodiment is the laser scanning multiphoton excitation microscope. In another embodiment, the aforementioned configuration can be applied to a laser scanning confocal microscope.

When using this configuration, since the very small spot is formed at the observation subject A as the final image IF which is made clear, photon density can be increased at a very small area and then fluorescence is generated, and It becomes possible to obtain a bright confocal image by increasing the fluorescence passing through the confocal pinhole.

Further, in the confocal microscope, it is also possible to detect light reflected or scattered at the observation subject A instead of detecting fluorescence passing through the confocal pinhole.

Next, An observation apparatus 30 will be described below with reference to the drawings.

In the explanation of this embodiment, the components which are the same as those of the first embodiment are indicated with the same reference symbols and the explanations for those components are omitted.

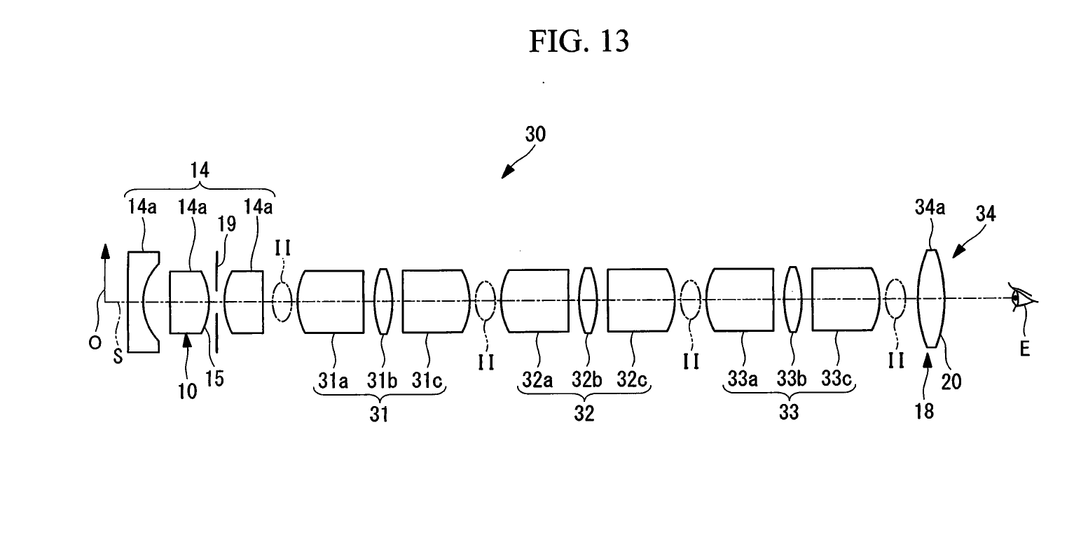

As shown in FIG. 13, the observation apparatus 30 according to this embodiment is different from the observation apparatus 1 of the first embodiment with the point that the apparatus 30 does not have the Z-scanning portion 8 and the galvanometer mirrors 16 and 17.

The observation apparatus 30 is a rigid endoscope.

The observation apparatus 30 has an objective lens 14, relay lens pairs 31, 32, 33, and an eyepiece 34, which are arranged in this order from the observation subject O. In this embodiment, intermediate images II are formed at four positions between respective elements of the objective lens 14, relay lens pairs 31, 32, and 33, and the eyepiece 34.

The objective lens 14 has a plurality of lenses 14a which form the intermediate image II, and a wavefront disturbing element 10 which is integrated with at least one of the lenses 14a which is located at a vicinity of the pupil position of the objective lens 14.

The relay pair 31 has an imaging lens 31b, and two field lenses 31a, 31c which are disposed so as to sandwich the imaging lens 31b in the direction of the optical axis S. The relay lens pair 32 has an imaging lens 32b, and two field lenses 32a, 32c. The relay lens pair 33 has an imaging lens 33b, and two field lenses 33a, 33c.

The eyepiece 34 has a convex lens 34a, and a wavefront restoration element 18 integrated with the convex lens 34a.

As the shape of the surface 15 of the wavefront disturbing element 10 and the shape of the surface 20 of the wavefront restoration element 18, any of the shapes of the first embodiment and its modified examples can be employed.

The operation of the thus-configured observation apparatus 30 according to this embodiment will be described below.

Light radiated from the observation subject O is focused by the objective lens 14, and a spatial disturbance is imparted to the wavefront by passing through the wavefront disturbing element 10. Then the light is made to pass the relay lens pairs 31, 32, 33, and form unclear intermediate images II. Further, the light is made to pass the eyepiece 34, and therefore the spatial disturbance of the wavefront imparted by the wavefront disturbing element 10 is canceled by passing through the wavefront restoration element 18. Thus, in the retina (not shown) of an eye E, a clear final image IF is observed.

Thus, since the intermediate images II are made unclear, even when there are scratches, foreign objects, or defects at vicinities of the intermediate images II, such as the surfaces or the insides of the field lenses 31a, 31c, 32a, 32c, 33a, 33c, it is possible to prevent deterioration of the final image IF due to the scratches, foreign objects, or defects from.

In this case, with the observation apparatus 30 according to this embodiment, since one of the lenses 14a, which constitute the objective lens 14, is integrated with the wavefront disturbing element 10, it is possible to dispose the wavefront disturbing element 10 at an arbitrary surface of an arbitrary optical element, which is an advantageous point, even in a case in which any spaces of the inside and the periphery of the objective lens 14 is very small, no matter whether the spaces may be near the pupil position or far from the pupil position, or no matter whether the objective lens 14 may be very small like most of the endoscope objective lens or not.

Note that since the galvanometer mirrors 16, 17 as described in the first embodiment as shown in FIG. 1 is not employed, in other words, since a scanner is not employed in this embodiment, it is not necessary that the wavefront disturbing element 10 is positioned so as to be consistent with the pupil surface of the objective lens 14, and it is sufficient that the wavefront disturbing element 10 is positioned at a vicinity of the pupil surface. Also, it is not necessary that the wavefront restoration element 18 is positioned so as to be consistent with the pupil surface of the eye E, and it is sufficient that the wavefront restoration element 18 is positioned at a vicinity of the pupil surface. Further, it is sufficient that the wavefront disturbing element 10 and the wavefront restoration element 18 are located at positions that are conjugate with each other.

The inventor has arrived at the following aspects of the invention.

An aspect of the present invention is an imaging optical system comprising: a plurality of imaging lenses that form a final image and at least one intermediate image; a first phase-modulating element that is disposed closer to an object than any one of the intermediate images formed by the imaging lenses, and that imparts a spatial disturbance to a wavefront of light coming from the object; and a second phase-modulating element that is integrated with at least one optical element which constitutes the imaging lens and which is positioned at a vicinity of a pupil position of the imaging lens so that at least one of the intermediate images are positioned between the at least one optical element and the first phase-modulating element, wherein the second phase-modulating element cancels the spatial disturbance imparted to the wavefront of the light coming from the object by the first phase-modulating element.

With this aspect, the light that has entered the imaging lenses from the object side thereof forms a final image after being focused by the imaging lenses. In this case, by passing through the first phase-modulating element that is disposed closer to the object side than one of the intermediate images, the spatial disturbance is imparted to the wavefront of the light, and thus, the formed intermediate images are made obscure and unclear. Since the light that has formed the intermediate images passes through the second phase-modulating element disposed at the vicinity of the pupil position of the imaging lens, the spatial disturbance imparted to the wavefront by the first phase-modulating element is canceled. With the aforementioned configuration, the final image formed after the second phase-modulating element is made clear.

In other words, even in the case in which the intermediate images are positioned in the vicinity of optical devices in which scratches, foreign objects, defects, or the like exist at the surfaces or the interiors thereof, by making the intermediate images unclear, it is possible to prevent the occurrence of a situation in which such scratches, foreign objects, defects, or the like become superimposed on the intermediate images, thus finally forming portions of the final image.

In this case, even when the space at the vicinity of the pupil position of the imaging lens is small, the second phase-modulating element, which is integrated with the optical element constituting the imaging lens, can be disposed as one of the optical elements which constitute the imaging lens. It is possible to dispose the second phase-modulating element at an arbitrary surface of the surfaces of the optical elements constituting the imaging lens, no matter whether it is positioned at a vicinity of the pupil position or at a position relatively far from the pupil position. Especially, by disposing the second phase-modulating element at a position which is very close to the pupil position, it becomes possible to prevent moving the position of the beam bundle passing through the second phase-modulating element even when a scanner or the like, which is for moving the position of the beam bundle, is located at a position on the optical axis, and even when the scanner or the like is operated. Thus, it is possible to completely cancel the spatial disturbance of the wavefront imparted by the first phase-modulation element, and then obtain a clear final image.

In the above-described aspect, the first phase-modulating element and the second phase-modulating element may impart phase modulations which change in an one-dimensional direction orthogonal to an optical axis.

With the aforementioned configuration, it is possible to make the intermediate images unclear by imparting the phase modulations which change in the one-dimensional direction orthogonal to the optical axis by the first phase-modulating element, and thereby it is possible to prevent a situation in which scratches, foreign objects, defects, or the like are superimposed on the intermediate images and then the scratches, foreign objects, defects, or the like are formed as a part of the final image, even when the intermediate images are formed at positions which is close to the optical elements having the scratches, foreign objects, defects, or the like exist at the surfaces or the interiors thereof. By imparting the phase modulation, which cancels the phase modulation changing in the one-dimensional direction, to the wavefront of the light by the second phase-modulating element, it is possible to form a final image which is not obscure and clear.

In the aforementioned aspect, the first phase-modulating element and the second phase-modulating element may impart phase modulations which change in a two-dimensional direction orthogonal to an optical axis.

With this configuration, it becomes possible to make the intermediate images unclear more effectively.

In the aforementioned aspect, the first phase-modulating element and the second phase-modulating element may be cylindrical lenses.

With this configuration, the first phase-modulating element generates astigmatism by an optical power in one direction orthogonal to the optical axis, and then the intermediate images can be made unclear. The second phase-modulating element is able to cancel the astigmatism.

In the aforementioned aspect, the first phase-modulating element and the second phase-modulating element may have mutually complementary shapes.

With this configuration, it becomes easy to configure a first phase-modulating element, which imparts a spatial disturbance to the wavefront for making the intermediate images obscure, and a second phase-modulating element, which impart a phase modulation which cancels the spatial disturbance imparted to the wavefront.

Another aspect of the present invention is an illumination apparatus comprising: an imaging optical system according to the aforementioned aspects; and a light source which is disposed at a position closer to an object than the imaging optical system and which generates light to be irradiated into the imaging optical system.

With this aspect, illumination light from the light source, which is located at the object side, is irradiated into the imaging optical system, and thereby the illumination light is irradiated onto the illuminated object which is located at the final image side. In this case, since the intermediate images, which are formed by the imaging optical system, is made unclear by the first phase-modulating element, even in the case in which the intermediate images are positioned in the vicinity of optical devices in which scratches, foreign objects, defects, or the like exist at the surfaces or the interiors thereof, it is possible to prevent the occurrence of a situation in which such scratches, foreign objects, defects, or the like become superimposed on the intermediate images, thus finally forming portions of the final image.

Another aspect of the present invention is an observation apparatus comprising: an illumination apparatus according to the aforementioned aspect; and a photodetector which detects light from the observation subject irradiated by the illumination apparatus.

With this aspect, it is possible to detect a clear final image which is formed, preventing the images of the scratches, foreign objects, defects, or the like, which exists on the surfaces or the insides of the optical elements, from being superimposed on the intermediate images by the imaging optical system.

In the aforementioned aspect, the light source may be a pulse laser light source.

With this configuration, it is possible to conduct an image observation in which scratches, foreign objects, defects, or the like is not superimposed at the positions of the intermediate images, and the image observation of the observation subject is conducted by a sharp multiphoton-excitation fluorescence.

The aforementioned aspects afford an advantage in that, even if an intermediate image is formed at a position that overlaps with an optical device, it is possible to obtain a clear final image by preventing scratches, foreign objects, defects, or the like of the optical device from becoming superimposed on the intermediate image.

### REFERENCE SIGNS LIST

1, 30 observation apparatus
2 illumination apparatus
3 imaging optical system
5 photodetector
6 wavefront disturbing element (first phase-modulating element)
11, 12, 13 relay lens pair (imaging lens)
14 objective lens (imaging lens)
18 wavefront restoration element (second phase-modulating element)
31, 32, 33 relay lens pair (imaging lens and field lens)
34 eyepiece

1. An imaging optical system comprising:
a plurality of imaging lenses that form a final image and at least one intermediate image;
a first phase-modulating element that is disposed closer to an object than any one of the intermediate images formed by the imaging lenses, and that imparts a spatial disturbance to a wavefront of light coming from the object; and
a second phase-modulating element that is integrated with at least one optical element which constitutes the imaging lens and which is positioned at a vicinity of a pupil position of the imaging lens so that at least one of the intermediate images are positioned between the at least one optical element and the first phase-modulating element, wherein the second phase-modulating element cancels the spatial disturbance imparted to the wavefront of the light coming from the object by the first phase-modulating element.

2. The imaging optical system according to claim 1, wherein the first phase-modulating element and the second phase-modulating element impart phase modulations which change in an one-dimensional direction orthogonal to an optical axis.

3. The imaging optical system according to claim 1, wherein the first phase-modulating element and the second phase-modulating element impart phase modulations which change in a two-dimensional direction orthogonal to an optical axis.

4. The imaging optical system according to claim 1, wherein the first phase-modulating element and the second phase-modulating element are cylindrical lenses.

5. The imaging optical system according to claim 1, wherein the first phase-modulating element and the second phase-modulating element have mutually complementary shapes.

6. An illumination apparatus comprising:
an imaging optical system according to claim 1; and
a light source which is disposed at a position closer to an object than the imaging optical system and which generates light to be irradiated into the imaging optical system.

7. An observation apparatus comprising:
an illumination apparatus according to claim 6; and
a photodetector which detects light from the observation subject irradiated by the illumination apparatus.

8. The observation apparatus according to claim 7, wherein the light source is a pulse laser light source.
